(19) United States
(12) Patent Application Publication
(10) Pub. No.: US 2013/0317654 A1
(43) Pub. Date: Nov. 28, 2013

(54) AIR-CONDITIONING CONTROL SYSTEM AND AIR-CONDITIONING CONTROL METHOD

(71) Applicants: Yasuhiro Kashirajima, Tokyo (JP); Junichi Ito, Nagareyama (JP); Ryoji Shimokawa, Higashimurayama (JP); Masakatsu Senda, Konosu (JP)

(72) Inventors: Yasuhiro Kashirajima, Tokyo (JP); Junichi Ito, Nagareyama (JP); Ryoji Shimokawa, Higashimurayama (JP); Masakatsu Senda, Konosu (JP)

(73) Assignee: Hitachi, Ltd., Tokyo (JP)

(21) Appl. No.: 13/981,744

(22) PCT Filed: Jan. 18, 2012
(86) PCT No.: PCT/JP2012/050997

§ 371 Date: Jul. 25, 2013

(30) Foreign Application Priority Data
Jan. 25, 2011 (JP) 2011-012679

(51) Int. Cl. G05D 23/19

(52) U.S. Cl. CPC G05D 23/19
USPC 700/276

(57) ABSTRACT

An air-conditioning control system is equipped with: a first client server containing a job management program that manages jobs for multiple electronic devices; a second client server that determines the required amount of cooling on the basis of the power information for the multiple electronic devices that is output from this first client server, and outputs information that controls the operation of multiple air-conditioners; an integrated management server that inputs information from the first and second client servers; and a control board that controls the operation of the air-conditioners on the basis of commands from the integrated management server. An environment optimization control program, which calculates the temperature distribution and airflow in an electronic device facility when the operation of the air-conditioners is controlled on the basis of the input power information for the electronic devices and the required amount of cooling, is installed in the integrated management server.

### TECHNICAL FIELD

The present invention relates to an air-conditioning control system and air-conditioning control method for a facility having a plurality of electronic devices and more particularly to an air-conditioning control system and air-conditioning control method suitable for a large-scale electronic device facility such as a datacenter.

### BACKGROUND ART

In a datacenter or the like, there is a growing tendency that electronic devices are installed densely to improve the area efficiency and as a consequence, the heat generated by the electronic devices may amount to 1.0 to 1.5 kW/m². Therefore, there is a need to cool the electronic devices quickly with less power consumption.

Patent Document 1 describes an air-conditioning system which air-conditions a plurality of rooms by at least one outdoor unit. According to this document, in order to reduce energy consumption sufficiently, the air-conditioning system includes a plurality of indoor units located in a room and determines the number of indoor units to be operated, based on outdoor thermal energy supplied from the outdoor unit, specification data on the indoor units, a request from each indoor unit, and all electric energy of the air-conditioning system and stops operation of indoor units in excess of the number of indoor units to be operated.

Patent Document 2, in order to achieve both energy saving and environmental conservation by controlling an air conditioner in conjunction with operation of an electronic device, a plurality of servers are housed in a plurality of server racks installed in a server room and a system for cooling the electronic device monitors the heat generation of each server in each server rack. A temperature control zone is set for every several server racks and an air conditioner is provided for each temperature control zone to change the operating condition of the air conditioner in each temperature control zone.

Patent Document 3 describes that the temperature distribution in the vertical direction of the gas space in an air-conditioned room is measured and the supplied air flow is adjusted by fuzzy control, based on the relation between the temperature distribution and the air conditioner outlet temperature.

### PRIOR ART DOCUMENT

### Patent Document

Patent Document 1: Japanese Patent Application Laid-Open No. 2006-220345
Patent Document 2: Japanese Patent Application Laid-Open No. 2010-108115
Patent Document 3: Japanese Patent Application Laid-Open No. H8 (1996)-159542

### SUMMARY OF THE INVENTION

### Problem to be Solved by the Invention

However, when a facility in which electronic devices are densely installed as in a datacenter and the temperature control accuracy in air conditioning must be high is cooled to avoid an operational failure, the conventional approach is to operate a plurality of cooling means almost to their full extent. However, in order to address environmental issues and reduce power consumption, they must be operated more efficiently for energy saving.

The air-conditioning system described in the Patent Document 1 is not intended to deal with the heat generated by precision devices such as electronic devices and does not pay due consideration to decreasing the temperature of the object to be cooled which generates heat itself, to a given level. In other words, the technique in this document deals with loads caused by general environmental factors and is not intended to save energy in a case that a certain level of load is predictable.

The electronic device cooling system described in the Patent Document 2 is intended to cool electronic devices like ones in a datacenter to a given temperature, in which detailed data on loads is available and thus a higher level of energy saving than before can be achieved. However, even in the technique described in the Patent Document 3, there is a need for further energy saving and more active acquisition of load data is an important issue.

The air conditioner described in the Patent Document 3 is intended to quickly resolve the temperature distribution in the vertical direction of the air-conditioned area. If this system is applied to an area with a high heat generation density in which servers or the like are densely installed, such as a datacenter, there is a restriction on the locations of temperature sensors or the like, so the system does not always bring about an effect which is required for electronic devices.

The present invention is intended to solve the problem of the above related art and has an object to provide an air-conditioning system and air-conditioning control method for efficiently cooling an electronic device which is required to operate with high precision and generates a large amount of heat, such as a computer or server.

### Means for Solving the Problems

In order to achieve the above object, according to one aspect of the present invention, there is provided an air-conditioning control system for air-conditioning an electronic device installation room housing a plurality of electronic devices by a plurality of air conditioners and the system includes an integrated management server which calculates a required amount of cooling energy based on power data on the electronic devices as sent from a first client server including a job management means for managing jobs for the electronic devices and outputs information to control operation of the air conditioners, and a control panel which controls operation of the air conditioners based on a command from the integrated management server, in which the integrated management server includes an environment optimization means to calculate a temperature distribution in the electronic device installation room in controlling operation of the air conditioners based on the required amount of cooling energy and sends a command for controlling operation of the air conditioners to the control panel so that the temperature distribution calculated using the environment optimization means is within a predetermined permissible range.

In order to achieve the above object, according to another aspect of the present invention, there is provided an air-conditioning control method for air-conditioning an electronic device installation room housing a plurality of electronic devices by a plurality of air conditioners and the method includes the steps of obtaining power data on the electronic devices by a first client server including a job management means for managing jobs for the electronic devices, calculating a required amount of cooling energy needed for air-conditioning the electronic devices, based on the power data on the electronic devices as obtained by the first client server and calculating information to control operation of the air conditioners, and the integrated management server giving an operation command to the control panel, in which at the step of the integrated management server giving the operation command to the control panel, a command to control operation of the air conditioners is sent to the control panel so that a temperature distribution obtained using an environment optimization means for calculating a temperature distribution and an air current in the electronic device installation room is within a predetermined permissible range when operation of the air conditioners is controlled based on the power data on the electronic devices and the required amount of cooling energy.

In the above system and method, the required amount of cooling energy may be a sum of actual power consumption of the electronic devices, or the required amount of cooling energy may be a sum of actual power consumption of the electronic devices or a sum of future power consumption of the electronic devices as predicted by the first client server according to a job plan which the first client server receives, whichever is larger, or provided that each air conditioner includes a return air temperature sensor for detecting a temperature of air flowing into the air conditioner, a supply air temperature sensor for detecting a temperature of outflowing air, and a means for detecting a frequency of a fan of the air conditioner and the second client server or the integrated management server calculates an amount of currently used cooling energy based on outputs from the return air temperature sensor, the supply air temperature sensor, and the frequency detecting means, the required amount of cooling energy may be a sum of actual power consumption of the electronic devices, or a sum of future power consumption of the electronic devices as predicted by the first client server according to a job plan which the first client server receives, or the calculated amount of currently used cooling energy, whichever is the largest.

### Effect of the Invention

According to the present invention, the amount of heat generated by an electronic device itself can be estimated from data on the operation of the electronic device, so the air-conditioning system can prevent a computer or server from malfunctioning due to overheating and efficiently cool the electronic device which generates a large amount of heat.

### BRIEF DESCRIPTION OF THE DRAWINGS

FIG. 1 is a block diagram of an embodiment of an air-conditioning control system 100 according to the present invention.

FIG. 2 is a top view of an example of an electronic device facility which is air-conditioned by the air-conditioning control system according to the present invention.

FIG. 3 is a side view of an electronic device facility shown in the FIG. 2.

FIG. 4 is a flowchart for controlling an embodiment of the air-conditioning control system according to the present invention.

### BEST MODE FOR CARRYING OUT THE INVENTION

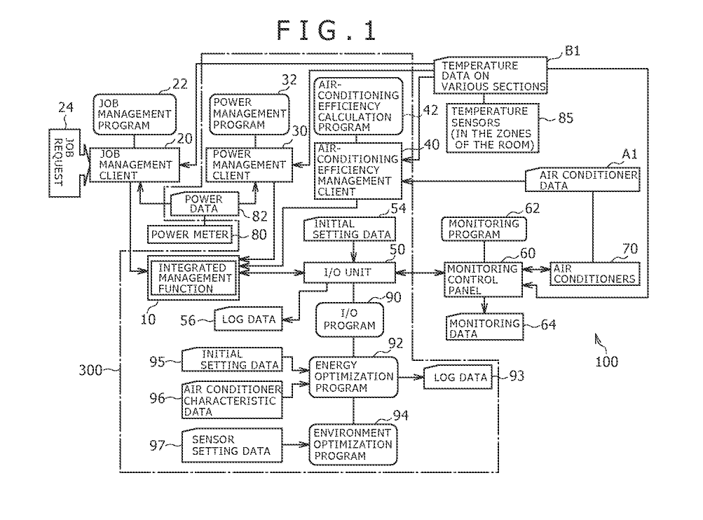

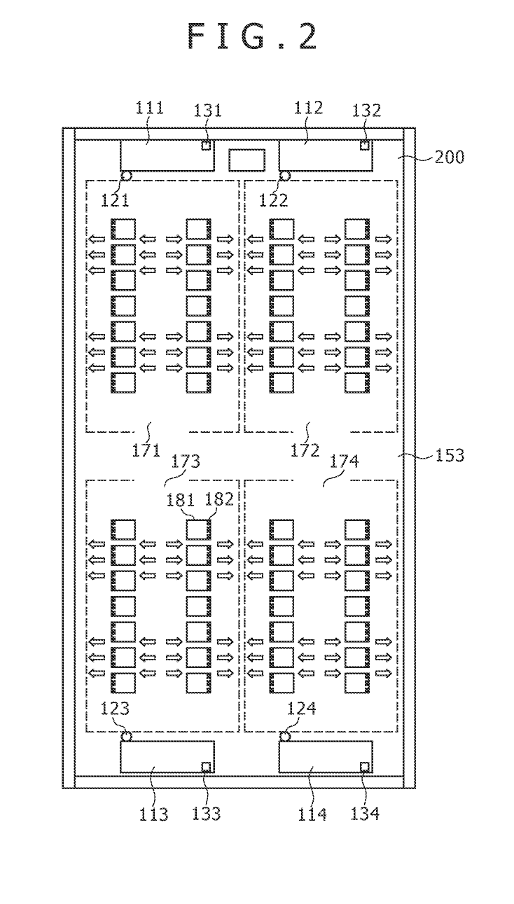

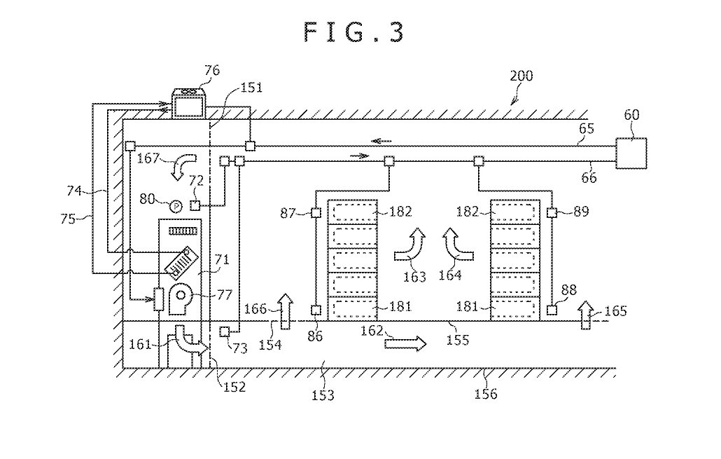

Next, an embodiment of the present invention will be described referring to drawings. FIG. 1 is a block diagram of an air-conditioning control system 100 according to the present invention and FIG. 2 is a plan view of a server room in which the air-conditioning control system 100 is installed. FIG. 3 is a fragmentary longitudinal sectional view of the server room shown in FIG. 2, schematically illustrating the air conditioners and air currents.

In FIG. 1, a block enclosed by a rectangle represents hardware and a block enclosed by a corner-rounded rectangle represents software. A block enclosed by a rectangle with a left upper corner missing represents data. A software program is loaded on a piece of hardware connected to it by solid line. An integrated management function 10 which is the core of an integrated management server 300 as enclosed by dashed line centrally controls the air-conditioning control system 100 in the present invention and is connected to a job management client server 20 and a power management client server 20, a power management server 30, and an air-conditioning efficiency management server 40 by communication means such as LAN and the Internet respectively.

The job management client server 20 controls job management which will be described later and upon receiving a job request 24, manages the operation of an electronic device using a job management program 22 to respond to the job request. At this time, job management is done using power data 82 detected by a power meter 80 and temperature data on zones B1 as detected by temperature sensors 85 which will be detailed later.

The power management client server 30 sends power consumption status information and a management guideline to the integrated management function 10, based on the temperature data on zones B1 and power data 82 and using a power management program 32, in order to perform efficient power management.

The air-conditioning efficiency management client server 40 optimizes the air-conditioning efficiency according to an air-conditioning efficiency calculation program 42 which will be detailed later, using the temperature data on zones B1 and data on air conditioners A1. At this time, as the integrated management function 10 receives various setting data from the client servers 20 to 40, the integrated management function 10 integrates the various setting data in accordance with a predetermined criterion to optimize power utilization. Then it sends a command for settings of the air conditioners 70 to a monitoring control panel 60 through an I/O unit 50. Following the command from the integrated management function 10, the monitoring control panel 60 sends an operation command to various parts of the air conditioners 70 using a monitoring program 62. The monitoring control panel 60 outputs monitoring data 64 which indicates the operation status of the air conditioners 70 and the I/O unit 50 outputs log data 56 which indicates the operation status of the air-conditioning control system 100.

The I/O unit stores an I/O program 90 and an energy optimization program 92 and environment optimization program 94 relating to the program 90. The energy optimization program 92 makes calculations in reference to characteristic data 96 on the air conditioners 70 stored in a storage means in the form of a database and initial setting data 95 for the initial setting of the air conditioners 70 and outputs log data 93. The environment optimization program 94 calculates how to operate the air conditioners 70 to minimize the environmental load, in reference to sensor setting data 97 including data on the arrangement of the temperature sensors 85 stored in a storage means in the form of a database.

Although these programs 90, 92, and 94 are stored in the I/O unit 50 in this embodiment, instead the integrated management function 10 or the monitoring control panel 60 may have an input/output function and store these programs. FIG. 1 is a diagram for easy explanation of various functions.

Next, an example of an electronic device facility to which the air-conditioning control system 100 is actually applied will be described referring to FIGS. 2 and 3. FIG. 2 shows an example of a server room 200 as part of a datacenter in which many servers (electronic devices) are mounted in server racks. In the server room 200, a plurality of air conditioners 111 to 114 are installed along walls (two units against each of wall surfaces opposite to each other in the figure). Return air temperature sensors 131 to 134 for detecting the temperature of air sucked in from the server room 200 and supply air temperature sensors 121 to 124 for detecting the temperature of conditioned air discharged from the air conditioners 111 to 114 are attached to the air conditioners 111 to 114 respectively.

The server room 200 is substantially divided into zones which correspond to the air conditioners 111 to 114 and the air conditioner 111 mainly air-conditions the zone 171 and the air conditioner 112 air-conditions the zone 172. The air which is conditioned by the air conditioners 111 to 114 is passed through an underfloor passage 153 and supplied to the zones 171 to 174 respectively. In each of the zones 171 to 174, a plurality of rows (two rows in the figure) of server racks 182 (seven racks per row in the figure) are installed and these server racks each have a plurality of shelves arranged vertically. A server 181 is placed on each shelf. This means that many servers are installed in the server room 200 and the heat generated by these servers must be quickly and efficiently discharged.

FIG. 3 is a sectional view showing part of the server room 200 schematically. The air conditioner 71 located against the wall is a so-called package type air conditioner which sends conditioned air 161 through a partition wall 152 to the underfloor passage 153 formed between a floor surface 155 and an underfloor wall surface 156 by a blower fan. The floor surface constitutes a grating 154, so while conditioned air 162 flows in the underfloor passage 153, upward air currents 165 and 166 which go into the server room through the clearance gaps of the grating 154 are formed.

The server racks 182 are located on the floor surface 155 as mentioned above and the conditioned air currents 165 and 166 coming from the grating 154 exchange heat with the servers 181 mounted in the server racks 182 and their temperatures go up, resulting in the formation of upward air currents 163 and 164. These upward air currents 163 and 164 go through a partition wall 151 for partitioning the installation space of the air conditioner 71 against the wall and turn into an inflow current 167 which exchanges heat with cooling water and refrigerant through a heat exchanger provided in the air conditioner 71, generating conditioned air. This cycle is repeated to cool the servers 181 to below a prescribed temperature.

The heat exchanger of the air conditioner 71 works for so-called free cooling, in which it exchanges heat between the air in the server room 200 whose temperature has risen and the cooling water whose latent heat is lost when the compressor is out of operation. When the compressor is in operation, in the heat exchanger which functions as a condenser, heat exchange takes place between the refrigerant and the cooling water having passed through a cooling tower 76 and in the heat exchanger which functions as an evaporator, heat exchange takes place between the air in the server room 200 whose temperature has risen and the refrigerant. For this reason, pipes 74 and 75 are provided to enable cooling water to circulate through the cooling tower 76.

As described above, the return air temperature sensor 72 is located near the intake side of the air conditioner 71 and the supply air temperature sensor 73 is located near the discharge side thereof. The temperature data detected by these sensors 72 and 73 is sent through a communication line 66 such as LAN to the monitoring control panel 60. On the other hand, an operation control command is sent from the monitoring control panel through a communication line 65 such as LAN to the air conditioner 71.

For the purpose of optimization of the environment, temperature sensors 86 to 89 are located near the top and bottom shelves of each server rack 182. Above these temperature sensors 86 to 89, temperature data is also sent through the communication line like LAN to the monitoring control panel 60. Although temperature data is collected in the monitoring control panel in this embodiment, it is needless to say that the data may be sent to a separate client server or the integrated management function 10 instead.

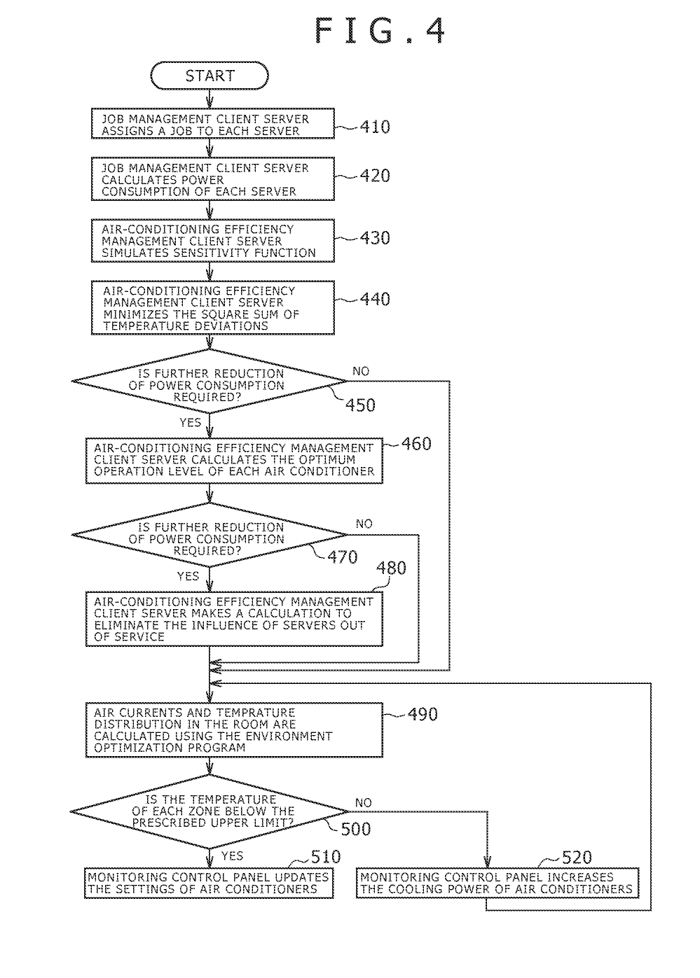

An example of operation of the air-conditioning system in the present invention which is intended to achieve both environmental load reduction and air-conditioning efficiency improvement in the air-conditioning control system thus configured will be explained referring to the flowchart of FIG. 4. First, as a job request 24 is issued from a user, the job program is executed to perform calculations and control operations using the servers. The job management client server 20 optimizes the job.

For example, the method described in JP-A-2009-252056 is adopted to optimize the job. This method uses two types of processing policies. (1) When an order of priority is set for jobs, priority order indices are given to assign jobs to a plurality of servers and the job to be assigned to each server is determined. (2) Taking power consumption of each server into consideration, a job is assigned to the server so as to minimize the power consumption (Step 410). In either of these policies, power consumption is calculated from server location information and position information including environmental information (Step 420).

The location information includes position coordinates and identification data of the servers 181 and inter-server connection data. The environmental information includes server operation data and performance characteristic data and ambient environment monitoring data such as electric power, temperature, humidity, flow rate, flow direction, rated output power, and rated performance. The performance characteristic data includes supply power loss characteristics and power consumption characteristics. These are stored in the form of a database.

Once jobs are assigned, the amount of generated heat or cooling load is calculated using the air-conditioning management client server 40. For example, the method described in JP-A-2010-78218 is adopted for this purpose. Since this method uses sensitivity analysis, sensitivity analysis data is prepared using a simulator. Specifically, how the temperature of conditioned air which flows into, and from, each server 181 changes when the outlet temperature (supply air temperature) of each of the air conditioners 111 to 114 is changed, and how the temperature of the return air into each of the air conditioners 111 to 114 changes when the temperature of conditioned air flowing out of each server 181 is changed are actually measured or estimated by a simulator (Step 430).

The supply air temperature of each of the air conditioners 111 to 114 (temperatures detected by the supply air temperature sensors 121 to 124) which minimizes the evaluation function as the square sum of deviations between the temperature of conditioned air currently flowing into each server 181 and the permissible maximum temperature of inflowing conditioned air is determined (Step 440). If this value has a sufficient difference from an estimated value or ever-changing updates by real-time calculations are desired, the calculation here is stopped (Step 450) and setting data for the air conditioners 111 to 114 to attain such supply air temperatures is sent to the integrated management function 10.

If further reduction of power consumption is desired, the air conditioners 111 to 114 are operated under conditions as close to the optimum operating conditions as possible. Specifically, setting data is sent to the integrated management function 10 so that the compressor operation level is changed to an operation level at which the supply air temperatures (outlet temperatures) of the air conditioners 111 to 114 are the temperatures determined at Step 430 and the power consumption is minimized (Step 460).

For further reduction of power consumption (Step 470), the servers 181 which are out of service or not executing the jobs though turned on are selected and the influence of these servers is eliminated from the above evaluation to determine the operation levels of the air conditioners 111 to 114 (Step 480). Thus, by controlling only the temperatures of the servers 181 which are currently executing the jobs, further reduction of power consumption can be achieved.

In terms of reducing power consumption while the servers 181 as heat generators to be cooled are nearly at their maximum operable temperatures, a considerable effect is produced simply by carrying out the above steps. However, further improvement is to be made in terms of reducing environmental load. Therefore, considering environmental load, the air currents and temperature distribution in the server room 200 are calculated according to the environment optimization program 94, also using data from the temperature sensors 86 to 89 (Step 490)

Whether or not the temperature of each zone in the server room 200 is above a predetermined upper limit or heat buildup occurs can be decided based on the calculation of air currents (Step 500). Consequently, not only heat buildup is suppressed but also if heat buildup should be predicted, it is possible to prevent the temperatures of the servers 181 from going up abnormally due to local temperature rise by increasing the cooling power of the air conditioners or changing the job (Step 520). If the air conditioners are preset to operate only when there is no heat buildup (Step 510), power consumption is reduced.

In the above embodiment, the thermal load generated by the servers 181, namely the required amount of cooling energy of the air conditioners, has been calculated by either of the following two methods: (1) the calculation is made on the basis of the operation status (calculated value) of the job assigned by the job management client server 20 (Step 420) and (2) instead of Step 420, the calculation is made by detecting the heat generation (power consumption) of the servers 181 resulting from the actual job operation. If the latter method is used, the required amount of cooling energy (thermal load) is obtained as direct electric power consumption, which offers an advantage that the amount of load is easily known and the air conditioners can be controlled in real time. This method is effective when load variation is large.

In addition, the required amount of cooling energy (load) can also be predicted according to the job operation plan of the job management client server 20. This is effective as a proactive measure when large load variation is expected to occur in the future. When a server is cooled by an air conditioner, it is difficult to avoid a time lag from input of a cooling condition updating signal to the air conditioner until the server is actually cooled to a prescribed temperature. According to the past experience, a time lag of about 5 minutes may occur in some cases. In the past, due to such a time lag, load variation could not be dealt with and an excessive cooling capacity was used with a resulting increase in power consumption.

The above embodiment compensates for such a time lag and permits energy saving. In this case, if the predicted required amount of cooling energy or the required amount of cooling energy calculated from the heat generation (power consumption) of the server 181, whichever is larger, is taken as the required amount of cooling energy and instead of Step 420 in FIG. 4 the integrated management function 10 runs the air conditioners 70, power consumption is reduced without an excessive load on the servers 181.

Furthermore, since the difference between the return air temperature and supply air temperature of each of the air conditioners 111 to 114, multiplied by the amount of air flowing into each of the air conditioners 111 to 114 may be considered as thermal load, optimum operation can be performed according to the sequence shown in FIG. 4 by taking as cooling load the largest one among three values, namely the amount of heat processed by the air conditioner, the power consumption of the servers 181 at the present (measured value), and the predicted power consumption of the servers in the future, instead of Step 420. Therefore, when the air conditioners are controlled by finding the largest one among the above three values at regular time intervals, high reliability is ensured and power consumption is reduced without an excessive load on the servers 181. Here, if the blower fan 77 of the air conditioner 71 is an inverter-controlled blower fan, the amount of inflowing air can be calculated from the inverter frequency and the fan characteristic data.

The above embodiment has been so far explained by taking an example of air conditioning of a datacenter with many servers; however, the present invention is not limited to air conditioning of a datacenter but it may be applied to air conditioning of a facility including many devices that generate heat. Also, although the above explanation assumes that the air conditioners are package type air conditioners, the invention may also be similarly applied to the case of using absorption refrigerators with fan coil units.

Furthermore, in the above embodiment, in order to attain the optimum operation status of the air conditioners, namely attain the operation status in which a given air-conditioning performance is achieved with minimum power consumption, the required amount of cooling energy needed to calculate the operation status of the air conditioners is calculated based on one among a plurality of varying factors which is most contributory to safe operation, so rise in the room temperature which contributes to failures of electronic devices included in an electric device facility is suppressed. In addition, since the operation status of the air conditioners can be decreased according to load, energy saving is ensured and environmental load is reduced.

### DESCRIPTION OF REFERENCE NUMERALS

10 . . . Integrated management function
20 . . . Job management client server (first client server)
22 . . . Job management means (program)
24 . . . Job request
30 . . . Power management client server
32 . . . Power management means (program)
40 . . . Air-conditioning efficiency management client server (second client server)
42 . . . Air-conditioning efficiency calculation means (program)
50 . . . I/O unit
52 . . . Initial setting data
54 . . . Log data
60 . . . Monitoring control panel
62 . . . Monitoring program
64 . . . Monitoring data
65, 66 . . . Communication lines
70 . . . Air conditioners
71 . . . Air conditioner
72 . . . Return air temperature sensor
73 . . . Supply air temperature sensor
74, 75 . . . Cooling water pipe
76 . . . Cooling tower
77 . . . Blower fan
80 . . . Power meter
82 . . . Power data
85 to 89 . . . Temperature sensors
90 . . . Input/output management program
92 . . . Energy optimization means (program)
93 . . . Log data
94 . . . Environment optimization means (program)
95 . . . Initial setting data
96 . . . Air conditioner characteristic data
97 . . . Sensor setting data
100 . . . Air-conditioning control system
111 to 114 . . . Air conditioners
121 to 124 . . . Supply air temperature sensors
131 to 134 . . . Return air temperature sensors
151, 152 . . . Partition walls
153 . . . Underfloor chamber
154 . . . Grating
155 . . . Floor surface
156 . . . Underfloor wall surface
161 to 167 . . . Air currents
171 to 174 . . . Air-conditioned zones
181 . . . Server (electronic device)
182 . . . Server rack
200 . . . Server room
300 . . . Integrated management server
A1 . . . Air conditioner data
B1 . . . Temperature data

1. An air-conditioning control system for air-conditioning an electronic device installation room housing a plurality of electronic devices by a plurality of air conditioners, comprising:
an integrated management server which calculates a required amount of cooling energy based on power data on the electronic devices as sent from a first client server including a job management means for managing jobs for the electronic devices and outputs information to control operation of the air conditioners; and
a control panel which controls operation of the air conditioners based on a command from the integrated management server,
wherein the integrated management server includes an environment optimization means to calculate a temperature distribution in the electronic device installation room in controlling operation of the air conditioners based on the required amount of cooling energy and sends a command for controlling operation of the air conditioners to the control panel so that the temperature distribution calculated using the environment optimization means is within a predetermined permissible range.

2. The air-conditioning control system according to claim 1, wherein the required amount of cooling energy is a sum of actual power consumption of the electronic devices.

3. The air-conditioning control system according to claim 1, wherein the required amount of cooling energy is a sum of actual power consumption of the electronic devices or a sum of future power consumption of the electronic devices as predicted by the first client server according to a job plan which the first client server receives, whichever is larger.

4. The air-conditioning control system according to claim 1,
wherein each air conditioner includes a return air temperature sensor for detecting a temperature of air flowing into the air conditioner, a supply air temperature sensor for detecting a temperature of outflowing air, and a means for detecting a frequency of a fan of the air conditioner; and
wherein the second client server or the integrated management server calculates an amount of currently used cooling energy based on outputs from the return air temperature sensor, the supply air temperature sensor, and the frequency detecting means; and
wherein the required amount of cooling energy is a sum of actual power consumption of the electronic devices, or a sum of future power consumption of the electronic devices as predicted by the first client server according to a job plan which the first client server receives, or the calculated amount of currently used cooling energy, whichever is the largest.

5. An air-conditioning control method for air-conditioning an electronic device installation room housing a plurality of electronic devices by a plurality of air conditioners, comprising the steps of:
obtaining power data on the electronic devices by a first client server including a job management means for managing jobs for the electronic devices;
calculating a required amount of cooling energy needed for air-conditioning the electronic devices, based on the power data on the electronic devices as obtained by the first client server and calculating information to control operation of the air conditioners; and
the integrated management server giving an operation command to the control panel,
wherein at the step of the integrated management server giving the operation command to the control panel, a command to control operation of the air conditioners is sent to the control panel so that a temperature distribution obtained using an environment optimization means for calculating a temperature distribution and an air current in the electronic device installation room is within a predetermined permissible range when operation of the air conditioners is controlled based on the power data on the electronic devices and the required amount of cooling energy.

6. The air-conditioning control method according to claim 5, wherein the required amount of cooling energy is a sum of actual power consumption of the electronic devices.

7. The air-conditioning control method according to claim 5, wherein the required amount of cooling energy is a sum of actual power consumption of the electronic devices or a sum of future power consumption of the electronic devices as predicted by the first client server according to a job plan which the first client server receives, whichever is larger.

8. The air-conditioning control method according to claim 5,
wherein the second client server or the integrated management server calculates an amount of currently used cooling energy based on outputs from a return air temperature sensor, a supply air temperature sensor, and a frequency detecting means which are provided in each air conditioner; and
wherein the required amount of cooling energy is a sum of actual power consumption of the electronic devices, or a sum of future power consumption of the electronic devices as predicted by the first client server according to a job plan which the first client server receives, or the calculated amount of currently used cooling energy, whichever is the largest.
